(19) United States
(12) Patent Application Publication
(10) Pub. No.: US 2026/0324565 A1
(43) Pub. Date: Oct. 22, 2026

(54) CONTROL SYSTEM FOR MOBILE HYDRAULIC MACHINES

(71) Applicant: Barreto Manufacturing, Inc., La Grande, OR (US)

(72) Inventors: Mark Z. Lewis, Union, OR (US); Gregory L. Barreto, Coffman Cove, AK (US)

(73) Assignee: Barreto Manufacturing, Inc., La Grande, OR (US)

(21) Appl. No.: 19/648,673

(22) Filed: Apr. 15, 2026

Related U.S. Application Data
(60) Provisional application No. 63/791,158, filed on Apr. 18, 2025.
(60) Provisional application No. 63/830,138, filed on Jun. 25, 2025.

(51) Int. Cl. A01G 23/06

(52) U.S. Cl. CPC A01G 23/067

(57) ABSTRACT

A hydraulic machine such as a stump grinder includes a chassis having a front end portion and a rear end portion, a hydraulic working implement coupled to the front end portion of the chassis, and a control panel disposed at the rear end portion of the chassis. The control panel includes a first control having a palm rest and an actuator coupled to the palm rest, wherein the actuator is configured to be actuated relative to the palm rest by a palm of a first hand of an operator, and a second control spaced laterally apart from the first control and configured to be actuated by a second hand of the operator. The hydraulic machine is configured such that actuating both the first control and the second control initiates a function of the hydraulic working implement.

### CROSS REFERENCE TO RELATED APPLICATIONS

This application claims the benefit of U.S. Provisional Application No. 63/791,158, filed Apr.18, 2025, and U.S. Provisional Application No. 63/830,138, filed on Jun. 25, 2025, each of which is incorporated herein by reference in its entirety.

### FIELD

The present disclosure is related to hydraulic machines and control systems for operating hydraulic machines.

### BACKGROUND

Hydraulic machines are mechanical systems that utilize pressurized hydraulic fluid to operate hydraulic working implements. Example hydraulic machines include, but are not limited to, stump grinders, trenchers, tillers, sod cutters, saws, chippers, plows, planers, graders, scrapers, rakes, augers, excavators, bulldozers, diggers, loaders, skid steers, cement mixers, jackhammers, backhoes, forklifts, grapples, dumpers, snow throwers, and sweepers. Typical hydraulic machines include control systems that allow operators of the hydraulic machines to control one or more functions of the working implements.

### SUMMARY

Described herein are exemplary hydraulic machines with hydraulic working implements and control systems for controlling the working implements. The disclosed control systems include control panels with more ergonomic and intuitive arrangements of controls. Accordingly, the hydraulic machines, control systems, and methods of use disclosed herein can, among other things, overcome one or more of the deficiencies of typical hydraulic machines.

In a representative example, a hydraulic machine comprises a chassis comprising a front end portion and a rear end portion; a hydraulic working implement coupled to the front end portion of the chassis; and a control panel disposed at the rear end portion of the chassis, wherein the control panel comprises: a first control comprising a palm rest and an actuator coupled to the palm rest, wherein the actuator is configured to be actuated relative to the palm rest by a palm of a first hand of an operator; and a second control spaced laterally apart from the first control and configured to be actuated by a second hand of the operator, wherein the hydraulic machine is configured such that actuating both the first control and the second control initiates a function of the hydraulic working implement.

In any or all of the examples described herein, the hydraulic working implement is centered on the front end portion of the chassis.

In any or all of the examples described herein, the actuator of the first control comprises a lever pivotally coupled to the palm rest.

In any or all of the examples described herein, the palm rest of the first control comprises a slot extending along a length of the palm rest, and wherein the actuator is at least partially disposed within the slot.

In any or all of the examples described herein, the second control comprises a button configured to be depressed by the operator’s second hand.

In any or all of the examples described herein, the button of the second control is configured such that releasing the button after the function of the hydraulic working implement has been initiated does not stop the function of the hydraulic working implement.

In any or all of the examples described herein, the palm rest of the first control is positionally adjustable, length-adjustable, rotationally adjustable, or any combination thereof.

In any or all of the examples described herein, the hydraulic machine comprises an arm comprising a first end portion and a second end portion, wherein the first end portion of the arm is coupled to the front end portion of the chassis; the hydraulic working implement is coupled to the second end portion of the arm; and the hydraulic machine further comprises a third control configured to control a movement of the arm relative to the chassis.

In any or all of the examples described herein, the hydraulic machine is a stump grinder and the hydraulic working implement is a cutter wheel, and the stump grinder is configured such that actuating both the first control and the second control initiates rotation of the cutter wheel.

In any or all of the examples described herein, the first control and the third control are operable with the operator’s first hand.

In any or all of the examples described herein, the third control comprises a lever with a grip portion configured to be actuated by at least one finger of the operator’s first hand while the palm of the operator’s first hand is in contact with the first control.

In any or all of the examples described herein, the third control is configured as a lift lever to control vertical movement of the arm relative to the chassis.

In any or all of the examples described herein, the second control is spaced apart in the lateral direction from the third control.

In any or all of the examples described herein, the hydraulic machine further comprises a fourth control configured as a sweep lever to control horizontal movement of the arm relative to the chassis.

In any or all of the examples described herein, the hydraulic machine further comprises drive assembly controls, and wherein the first control is disposed on a first lateral side of the drive assembly controls and the second control is a button disposed on a second lateral side of the drive assembly controls.

In another representative example, a stump grinder comprises a chassis comprising a front end portion and a rear end portion; an arm comprising a first end portion and a second end portion, wherein the first end portion of the arm is coupled to the front end portion of the chassis, and wherein the arm is configured to move in at least one of a horizontal direction and a vertical direction relative to the chassis; a cutter wheel coupled to the second end portion of the arm; and a control panel disposed at the rear end portion of the chassis, wherein the control panel comprises: a first control configured as a palm-actuated switch assembly comprising a lever configured to be actuated by a palm of a first hand of an operator; and a second control configured as a button spaced apart in a lateral direction from the palm-actuated switch assembly, wherein the button is configured to be actuated by a second hand of the operator, wherein the stump grinder is configured such that actuating both the palm-actuated switch assembly and the button initiates a rotation of the cutter wheel.

In any or all of the examples described herein, the control panel comprises a third control configured as a lift lever to control vertical movement of the arm relative to the chassis.

In any or all of the examples described herein, the lift lever comprises a grip portion configured to be actuated by at least one finger of the operator’s first hand while the palm of the operator’s first hand is in contact with the palm-actuated switch assembly.

In any or all of the examples described herein, the control panel comprises a fourth control configured as a sweep lever to control horizontal movement of the arm relative to the chassis, and wherein the sweep lever is spaced apart from the palm switch assembly and the lift lever and configured to be actuated by the operator’s second hand.

In any or all of the examples described herein, the control panel further comprises drive assembly controls, wherein the palm-actuated switch assembly is disposed on a first lateral side of the drive assembly controls, and wherein the button is disposed on a second lateral side of the drive assembly controls.

In some examples, a hydraulic machine can include a chassis with a front end portion opposite a rear end portion, a hydraulic working implement coupled to the front end portion of the chassis, and a control panel disposed at the rear end portion of the chassis. The control panel can include a first control with a palm rest and an actuator coupled to the palm rest. The actuator can be configured to be actuated relative to the palm rest by a palm of a first hand of an operator. The control panel can further include a second control spaced laterally apart from the first control. The second control can be configured to be actuated by a second hand of the operator. The hydraulic machine can be configured such that actuating both the first control and the second control initiates a function of the hydraulic working implement.

In some examples, a hydraulic machine can include a chassis with a front end portion and a rear end portion and an arm with a first end portion opposite a second end portion. The first end portion of the arm can be coupled to the front end portion of the chassis. The hydraulic machine can further include a hydraulic working implement coupled to the second end portion of the arm and a control panel disposed at the rear end portion of the chassis. The control panel can include a first control, a second control, and a third control. The first control can include a palm rest and an actuator coupled to the palm rest. The actuator can be configured to be actuated relative to the palm rest by a palm of a first hand of an operator. The second control can be spaced apart in a lateral direction from the first control and can be configured to be actuated by a second hand of the operator. The third control can be configured to control a movement of the arm relative to the chassis. The hydraulic machine can be configured such that actuating both the first control and the second control initiates a function of the hydraulic working implement.

In some examples, a stump grinder can include a chassis with a front end portion and a rear end portion and an arm with a first end portion and a second end portion. The first end portion of the arm can be coupled to the front end portion of the chassis. The arm can be configured to move in at least one of a horizontal direction and a vertical direction relative to the chassis. The stump grinder can further include a cutter wheel coupled to the second end portion of the arm and a control panel disposed at the rear end portion of the chassis. The control panel can include a palm-actuated switch assembly with a lever configured to be actuated by a palm of a first hand of an operator and a button spaced apart in a lateral direction from the palm-actuated switch assembly. The button can be configured to be actuated by a second hand of the operator. The stump grinder can be configured such that actuating both the palm switch assembly and the button initiates a rotation of the cutter wheel.

The foregoing and other objects, features, and advantages of the disclosed technology will become more apparent from the following detailed description, which proceeds with reference to the accompanying figures.

### BRIEF DESCRIPTION OF THE DRAWINGS

FIGS. 1A-1B are isometric and side views of a hydraulic machine, according to one example.

FIG. 2A-2B are top-down and isometric views of a control panel of the hydraulic machine of FIGS. 1A-1B.

FIG. 3 is a side cross-sectional view of a palm switch assembly of the control panel of FIGS. 2A-2B.

FIG. 4 is an exploded isometric view of the palm switch assembly of FIG. 3.

FIG. 5 is a schematic diagram of a hydraulic circuit of the hydraulic machine of FIGS. 1A-1B.

FIG. 6 is a perspective view of a control panel of a hydraulic machine, according to another example.

FIG. 7 is a perspective view of a bracket of the control panel of FIG. 6.

### DETAILED DESCRIPTION

### General Considerations

For purposes of this description, certain aspects, advantages, and novel features of the examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing quantities of components, forces, moments, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing examples from discussed prior art, the example numbers are not approximates unless the word “about” is recited. Furthermore, not all alternatives recited herein are equivalents.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

### Overview of the Disclosed Technology

Described herein are examples of a hydraulic machine that includes a hydraulic working implement and a control system for controlling the working implement. In examples where the hydraulic machine is a stump grinder, the working implement can be a cutter wheel configured to grind or comminute a tree stump. The control system can include a control panel with a first control and a second control spaced laterally apart from the first control. The first control can be a palm-actuated switch assembly including a palm rest and an actuator coupled to the palm rest. The actuator can be configured to be actuated (e.g., depressed) relative to the palm rest by a palm of an operator’s first hand. The second control can be a button configured to be actuated by an operator’s second hand (e.g., a finger of the operator’s second hand). The hydraulic machine can be configured such that actuating both the first control and the second control initiates a function of the working implement (e.g., a rotation of the cutter wheel).

In some examples, the hydraulic machine can be additionally configured such that releasing one of the first control and the second control after the initiation of the working implement does not stop the operation of the working implement so long as the other control remains actuated. For example, when configured as a stump grinder with a cutter wheel, the hydraulic machine can be configured such that the second control can be released after the cutter wheel has started rotating without this release stopping the rotation of the cutter wheel so long as the actuator remains actuated, e.g., depressed.

In some examples, the hydraulic machine can additionally include a drive assembly configured to propel the hydraulic machine across the ground and one or more drive assembly controls for controlling the drive assembly. In some examples, the drive assembly control(s) for operating the drive assembly can be configured to be actuated by the operator’s second hand.

In some examples, the hydraulic machine can additionally include an arm configured to move the hydraulic working implement relative to the rest of the hydraulic machine and arm controls for controlling the movement of the arm. In some examples, a first one of the arm controls can be configured to be operated by one or more fingers of the operator’s first hand while the palm of the operator’s first hand rests on the palm rest of the palm switch assembly. This configuration of arm controls can beneficially allow the operator to control both the arm and the hydraulic working implement at the same time. A second one of the arm controls can be configured to be operated by the operator’s second hand.

A typical hydraulic machine can include a single control, e.g., a button, for initiating a function of a hydraulic implement. For example, a typical stump grinder can include a single button that, when pressed, initiates a rotation of a cutter wheel for grinding a tree stump. The typical stump grinder can be configured such that releasing the button stops the rotation of the cutter wheel; thus, the operator of the hydraulic machine must hold down the button during the entire stump grinding operation, which can last several hours, to maintain the rotation of the cutter wheel during the operation.

The exemplary hydraulic machines, control systems, and methods of use described herein provide several advantages over typical hydraulic machines. First, configuring the hydraulic machine to require the actuation of two controls by two different hands, e.g., by spacing the controls laterally apart from each other, further reduces the likelihood of inadvertently actuating both controls in a single motion. Additionally, requiring actuation by two different hands requires the operator to remain at the controls and behind the rear end portion of the hydraulic machine while starting the operation of the working implement.

Second, implementing at least one of the controls as a palm-actuated switch assembly instead of a finger-actuated button helps reduce finger fatigue because palm-actuated switch assemblies requires less effort to hold down than finger-actuated buttons over long periods of time.

Third, configuring the control system such that the second control (e.g., the button) can be released without stopping the working implement (e.g., without stopping the rotation of the grinding wheel) for so long as the first control (e.g., the palm-actuated switch assembly) remains actuated by the operator’s palm helps reduce finger fatigue by eliminating the need to depress the button over long periods of time, e.g., throughout the stump grinding process which can last hours or even a full day. Additionally, configuring the second control to be releasable without stopping the working implement can free the operator’s second hand to operate other controls. For example, the operator can use their second hand to operate the arm controls, thereby allowing the operator to sweep, raise, or lower the arm without stopping the working implement. In another example, the operator can use their second hand to operate the drive assembly controls, thereby allowing the operator to move the hydraulic machine across the ground (e.g., closer to a tree stump) without stopping the working implement.

Finally, the nature of the disclosed arrangement of controls makes it intuitive for operators to understand how to operate the controls, and also for instructors (e.g., equipment rental companies) to teach operators how to operate the disclosed hydraulic machines.

In addition, some examples of the hydraulic machine can be additionally configured such that the position of the palm rest of the first control can be adjusted relative to the second control and/or the rest of the control panel. For example, the palm rest assembly can include a bracket with at least one slotted hole (e.g., a plurality of slotted holes) that allows the palm rest to be coupled to the bracket at a selected one of a plurality of positions. Configuring the palm rest of the first control to be adjustable relative to the second control and/or adjustable relative to the rest of the control panel can allow the operator to adjust the palm rest to a more ergonomic position, thereby further improving operator comfort during use.

The disclosed technology is applicable to any hydraulic machine having a control system for operating a hydraulic working implement. Although the primary example of a hydraulic machine provided herein is a “stump grinder,” the following Detailed Description refers to stump grinders only as non-limiting examples in order to simply and succinctly illustrate the details of the disclosed technology. Thus, it should be understood that the term “hydraulic machine” generally encompasses hydraulically powered landscaping equipment and construction equipment, examples of which include—but are not limited to—trenchers, tillers, sod cutters, saws, chippers, plows, planers, graders, scrapers, rakes, augers, excavators, jackhammers, bulldozers, diggers, loaders, skid steers, cement mixers, backhoes, forklifts, grapples, dumpers, snow throwers, and sweepers, and the technology disclosed herein with respect to stump grinders is also applicable to other types of hydraulic machines.

### Example #1 of the Disclosed Technology

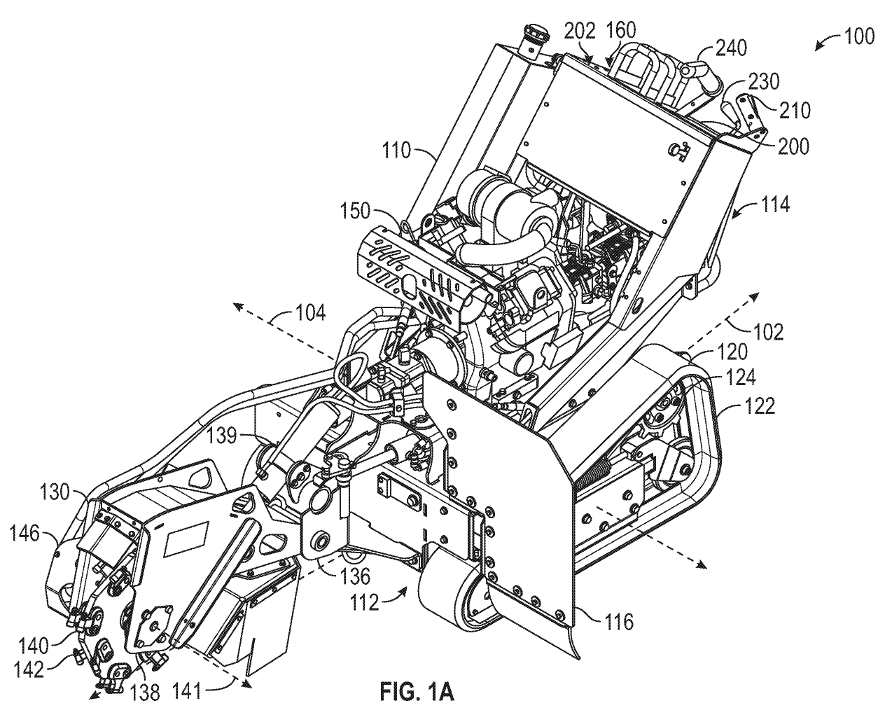

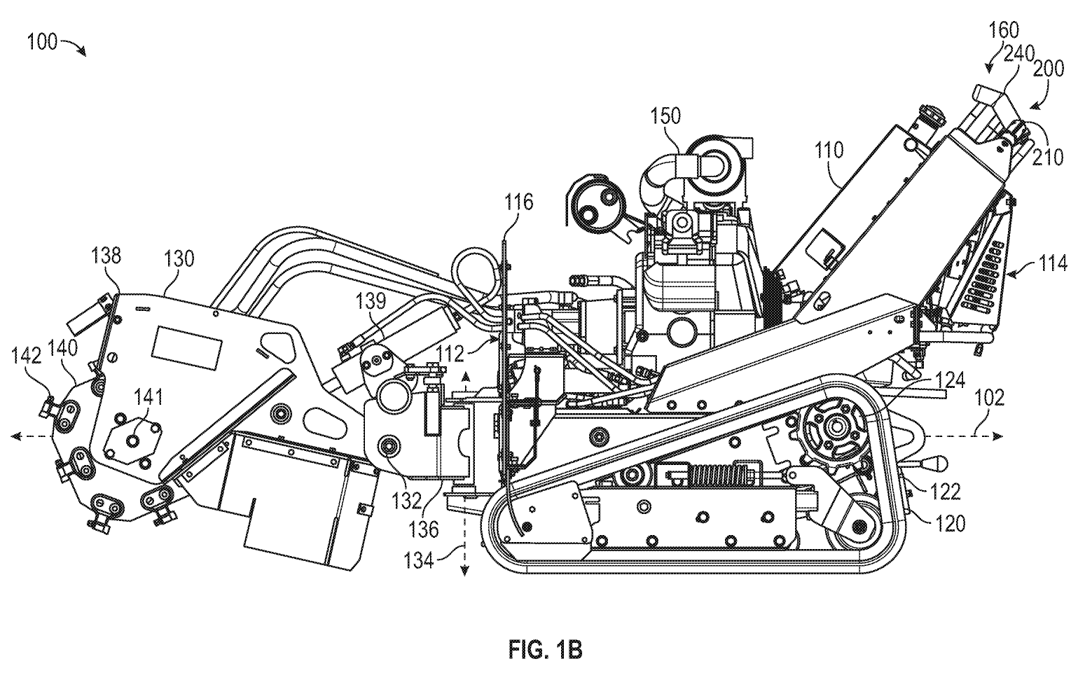

FIGS. 1A-1B depict various aspects of a hydraulic machine 100. Although the hydraulic machine 100 is depicted in these figures as being a stump grinder, it should be understood that these illustrations are non-limiting examples and the hydraulic machine 100 can be alternatively implemented as another type of hydraulic machine, e.g., any other of the hydraulic machines listed herein. The hydraulic machine 100 defines a longitudinal axis 102 defining a longitudinal direction (which is also referred to herein as a “fore-aft direction”) and a lateral axis 104 defining a lateral direction (which is also referred to herein as a “left-right direction”). The hydraulic machine 100 further includes a chassis 110, a drive assembly 120, an arm 130, a working implement 140, an engine assembly 150, and a control system 160.

The chassis 110 (which is also referred to herein as a “frame,” a “carriage,” and/or a “main body”) includes a front end portion 112 and a rear end portion 114. The chassis 110 is configured such that an operator of the hydraulic machine 100 can stand behind the rear end portion 114 during operation. In some examples, the hydraulic machine 100 can optionally include a chip guard 116 configured to at least partially shield an operator and/or a bystander from debris, e.g., wood chips, generated by the operation of the working implement 140. As shown, the chip guard 116 can be a plate mounted to a lateral portion of the chassis 110. In some examples, the hydraulic machine 100 can additionally or alternatively include a windshield (not shown) mounted between the working implement 140 and the control system 160. The windshield can be configured to protect the operator from flying debris. In some of these examples, the windshield can be substantially transparent such that the operator can view the working implement 140 through the windshield.

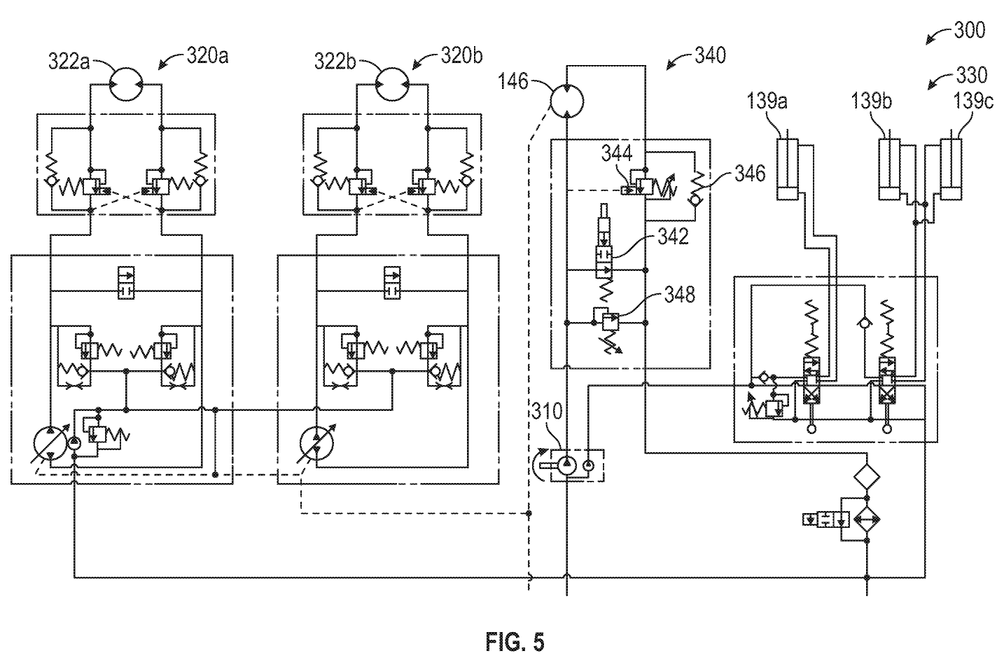

The hydraulic machine 100 further includes the drive assembly 120 configured to propel the hydraulic machine 100 across the ground. As such, the hydraulic machine 100 including the drive assembly 120 is also referred to herein as a “mobile hydraulic machine.” As shown, the drive assembly 120 includes one or more tracks 122 configured to engage the ground. In some examples, the drive assembly 120 can alternatively include tires configured to engage the ground or a combination of tracks and tires. The depicted drive assembly 120 includes one or more drive wheels 124 coupled to the tracks 122. Each drive wheel 124 is coupled to a respective motor 322, 322 (shown schematically in FIG. 5) configured to impart torque on the drive wheel 124 in order to propel the tracks 122 in a forward or reverse direction. The drive assembly 120 can be configured to steer the hydraulic machine left or right via differential steering (e.g., by operating left and right ones of the tracks 122 at different speeds).

The hydraulic machine 100 further includes the arm 130 (which is also referred to herein as a “hydraulic arm” and/or a “boom”) configured to move (e.g., pivot, swing, or sweep) in at least one of a vertical direction and a horizontal direction relative to the chassis 110. For example, the arm 130 can be configured to move about a horizontally extending pivot axis 132 (FIG. 1B) to raise and lower the arm 130 in a vertical direction relative to the chassis 110. Additionally or alternatively, the arm 130 can be configured to move about a vertically extending pivot axis 134 (FIG. 1B) to sweep the arm 130 left or right in a horizontal direction relative to the chassis 110. In some examples, the arm 130 can be configured to move in additional or alternative directions, such as in the longitudinal direction defined by the longitudinal axis 102. In some examples, portions of the arm 130 can be configured to move about additional pivot axes to provide the arm 130 with additional degrees of articulation.

As shown, the arm 130 includes a first end portion 136 and a second end portion 138. The first end portion 136 of the arm 130 can be coupled to the front end portion 112 of the chassis 110, e.g., at a location forward of the engine assembly 150. For example, as shown, the arm 130 and the front end portion 112 of the chassis 110 are connected at the vertically extending pivot axis 134. The placement of the arm 130 at the front end portion 112 of the chassis 110 can help distance an operator standing behind the rear end portion 114 of the hydraulic machine 100 from the working implement 140 mounted to the arm 130. Additionally or alternatively, the placement of the arm 130 at the front end portion 112 of the chassis 110 can help prevent other portions of the hydraulic machine 100 from obstructing the movement of the arm 130.

As shown, the arm 130 is centered on the front end portion 112 of the chassis 110. In other words, the arm 130 can be coupled to the chassis 110 such that the arm 130 is aligned with the longitudinal axis 102 that bisects the hydraulic machine 100. In some examples, the centered placement of the arm 130 can allow the operator to better view an entirety of a tree stump or another object being acted on by the working implement 140. Additionally or alternatively, the centered position can allow the operator to better observe potential obstructions on either side of the working implement 140 as the working implement 140, e.g., cutter wheel, is alternatingly moved leftward and rightward over the tree stump.

As shown, the hydraulic machine 100 includes one or more hydraulic cylinders 139 (which are also referred to herein as “hydraulic actuators”) coupled to the arm 130 and configured to move the arm 130 in a corresponding one of the one or more directions. FIGS. 1A-1B show one hydraulic cylinder 139 configured to move the arm 130 up and down in a vertical direction relative to the chassis 110. However, it should be understood that FIGS. 1A-1B show only one hydraulic cylinder 139 only for purposes of simplicity and ease of illustration, and that the hydraulic machine 100 can include additional hydraulic cylinders 139. For example, as discussed later herein with respect to FIG. 5, the hydraulic 139 shown in FIGS. 1A-1B can be a first hydraulic cylinder 139a, and the hydraulic machine 100 can include a second hydraulic cylinder 139b (FIG. 5) and/or a third hydraulic cylinder 139c (FIG. 5) configured to sweep the arm 130 leftward or rightward in a horizontal direction relative to the chassis 110.

The hydraulic machine 100 includes the working implement 140 mounted to the second end portion 138 of the arm 130. The working implement 140 is mounted to the second end portion 138 of the arm 130 such that moving the arm 130 in the horizontal and/or vertical directions moves the working implement 140 in the same horizontal and/or vertical directions.

Since working implement 140 depicted in FIGS. 1A-1B is a cutter wheel, the working implement 140 is also referred to herein for simplicity and ease of explanation as a “cutter wheel” and/or a “grinding wheel.” However, it should be understood that the working implement 140 can be a different type of hydraulically actuated working implement (e.g., a bucket, a trencher blade, a saw blade, a tiller rotor, an auger bit, etc.) in examples where the hydraulic machine 100 is not a stump grinder. The cutter wheel 140 can be configured to rotate about an axis 141 extending in the lateral direction. The depicted cutter wheel 140 includes a plurality of teeth 142 configured to comminute a tree stump.

As shown, the hydraulic machine 100 further includes a motor 146 configured to impart torque on the cutter wheel 140. The motor 146 can be mounted on the second end portion 138 of the arm 130 such that the motor 146 directly drives the cutter wheel 140. In some examples, the hydraulic machine 100 can include a belt, a gear box, or a transmission coupling the cutter wheel 140 and the motor 146. The motor 146 is depicted as a hydraulic motor configured to receive pressurized hydraulic fluid from a pump, e.g., the pump 310 schematically shown in FIG. 5, driven by the engine assembly 150. In some examples, the motor 146 can alternatively be an electric motor, a combustion motor, or any other type of motor.

The hydraulic machine 100 includes the engine assembly 150 configured to power one or more portions of the hydraulic machine 100. For example, the engine 150 can be configured to power the pump 310 schematically shown in FIG. 5, and the pump 310 can be configured to supply pressurized hydraulic fluid to various hydraulically powered portions of the hydraulic machine 100, e.g., the motors 322a, 322b (FIG. 5) configured to rotate the drive wheels 124 of the drive assembly 120, the cylinder 139 configured to move the arm 130, and/or the motor 146 configured to rotate the cutter wheel 140. As further shown, the engine assembly 150 is mounted to the chassis 110 between the front and rear end portions 112, 114 of the chassis 110. The engine assembly 150 can be mounted to the chassis 110 such that the engine assembly 150 does not substantially obstruct the operator’s view of the arm 130 and/or the working implement 140 when the operator is standing at a control panel 200 behind the rear end portion 114 of the chassis 110. In some examples, the engine assembly 150 can include a single engine or a plurality of engines. In some examples, the engine assembly 150 can include additional power sources, e.g., a battery or an alternator, configured to supply electrical power to one or more portions of the hydraulic machine 100.

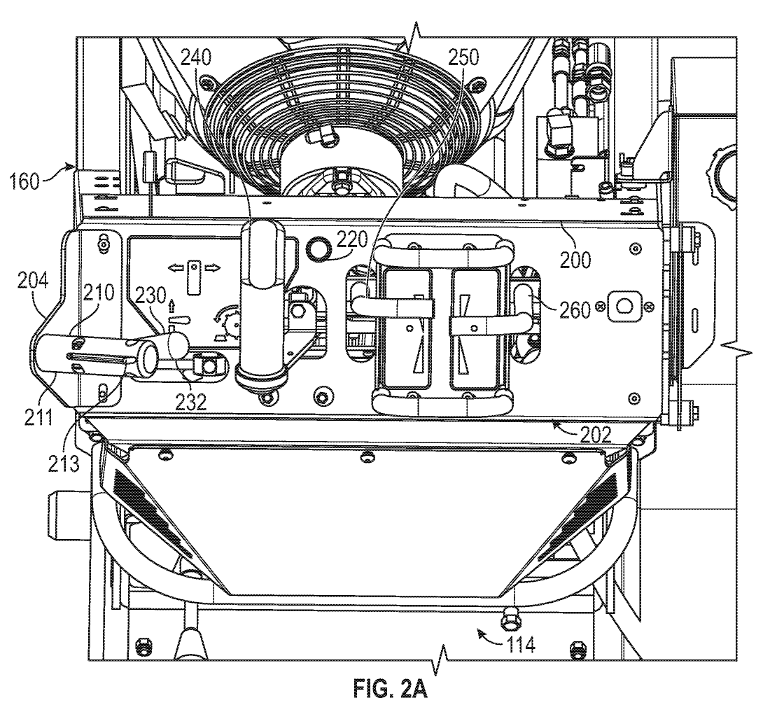

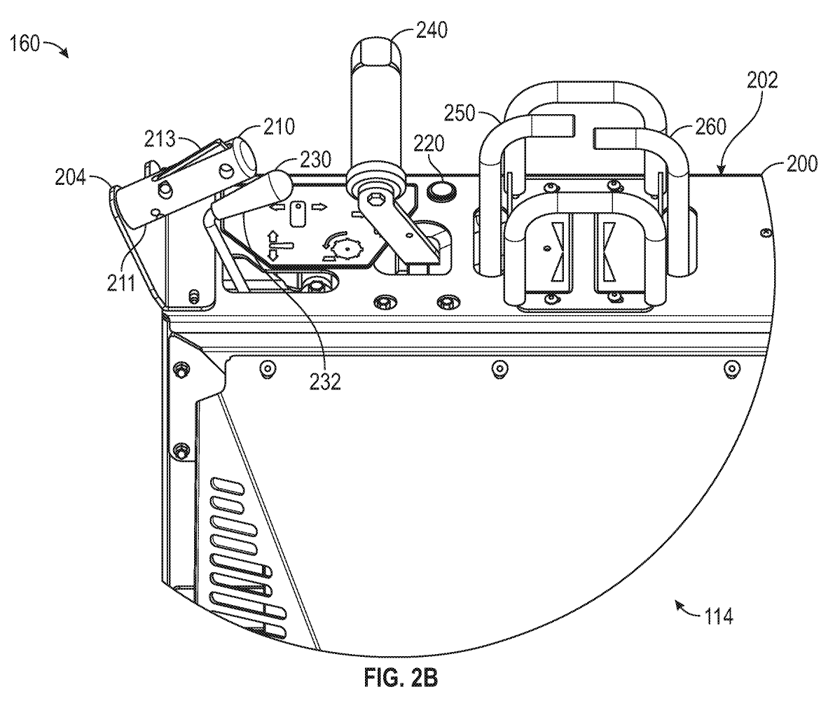

The hydraulic machine 100 includes the control system 160 configured to allow the operator to control one or more functions of the hydraulic machine 100. The control system 160 includes a control panel 200 which, as best shown in FIG. 1B, is disposed at the rear end portion 114 of the chassis 110. In some examples, disposing the control panel 200 at the rear end portion 114 of the chassis 110 can allow the forward-facing operator standing behind the rear end portion 114 to easily access and operate the controls. This position of the control panel 200 can also allow the operator to see both the working implement 140 and the control panel 200 at the same time, thereby beneficially reducing the need for the operator to take their eyes off the working implement 140 to view the control panel 200 and vice versa. As discussed below in further detail with respect to FIGS. 2A-2B, the control panel 200 can include controls for operating the drive assembly 120, the arm 130, and/or the working implement 140.

In some examples, the control system 160 can include a controller (not shown) configured to process input signals received from the controls of the control panel 200 and generate output signals to one or more electrical components (e.g., motors, solenoid valves, actuators) of the hydraulic machine 100. The controller can include one or more processing units and a tangible memory. The processing units can execute computer-executable instructions. A processing unit can be a general-purpose central processing unit (CPU), a processor in an application-specific integrated circuit (ASIC), or any other type of processor. In a multi-processing system, multiple processing units can execute computer-executable instructions to increase processing power. The tangible memory may be volatile memory (e.g., registers, cache, RAM), non-volatile memory (e.g., ROM, EEPROM, flash memory, etc.), or some combination of the two, accessible by the processing unit(s). The tangible memory may be removable or non-removable, and may include magnetic disks, magnetic tapes or cassettes, CD-ROMs, DVDs, or any other medium which can be used to store information and which can be accessed within the controller. The tangible memory can be configured to store software implementing one or more features described herein, in the form of computer-executable instructions suitable for execution by the processing unit(s).

In some examples, the controls of the control panel 200 can instead be electrically coupled to corresponding electrical components of the hydraulic machine 100 without the use of a controller.

FIGS. 2A-2B depict various aspects of the control panel 200 of the control system 160. The control panel 200 can define a surface 202 (best shown in FIGS. 1A, 2A, and 2B, ) oriented upwardly and rearwardly toward the operator. As shown, the control panel 200 includes a plurality of controls arranged on or extending through the surface 202, including a first control 210 and a second control 220 configured to control one or more functions of the working implement 140, a third control 230 and a fourth control 240 configured to control one or more functions of the arm 130, and a fifth control 250 and a sixth control 260 configured to control one or more functions of the drive assembly 120. Thus, the first and second controls 210, 220 are also collectively referred to herein as “working implement controls,” the third and fourth controls 230, 240 are also collectively referred to herein as “arm controls,” and the fifth and sixth controls 250, 260 are also collectively referred to herein as “drive assembly controls.”

In some examples, the control panel 200 can include additional controls (e.g., an engine ignition switch) configured to operate other functions of the hydraulic machine 100. In some examples, the control panel 200 can include one or more indicators (e.g., dials, lights, screens) configured to display a status of the hydraulic machine 100 to the operator.

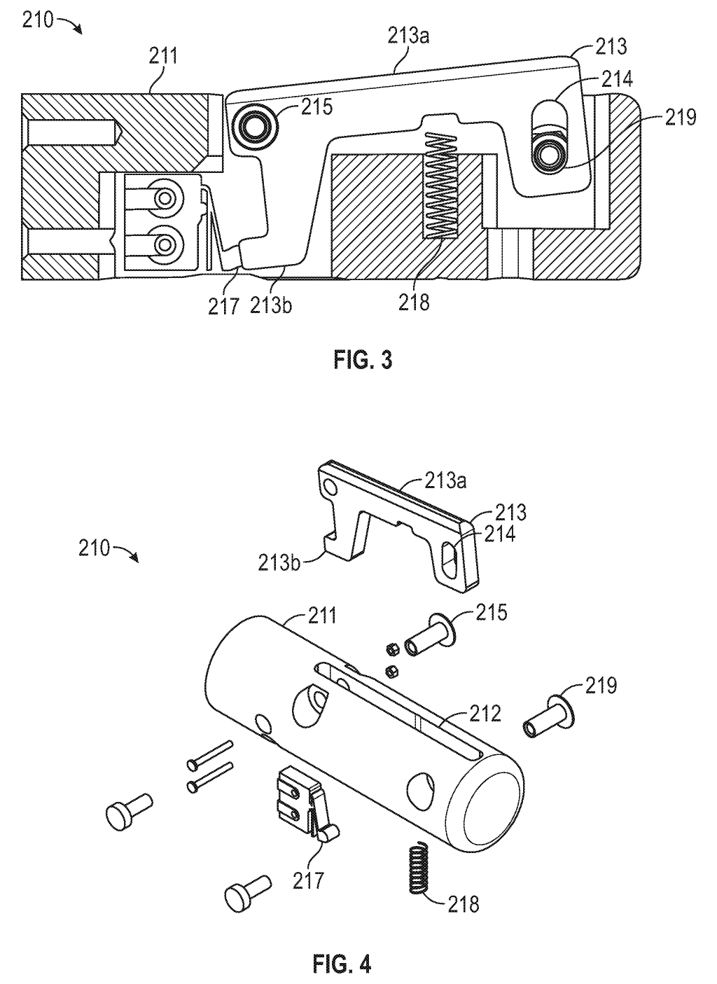

The first control 210 is depicted in FIGS. 2A-2B as a palm-actuated switch assembly and is thus also referred to herein as a “palm switch assembly” solely for purposes of simplicity and ease of explanation. The first control 210, which is further described with respect to FIGS. 3-4, includes a cylindrical member 211 configured as a handle that supports at least a portion of the operator’s first hand, e.g., a palm of the operator’s first hand, when the operator rests their first hand on the first control 210. Thus, the cylindrical member 211 is also referred to herein as a “palm rest” and/or a “handle.”

The first control 210 further includes an actuator 213 coupled to the cylindrical member 211. The actuator 213 is depicted in FIGS. 2A-4 as a lever configured to be actuated, e.g., depressed, toward the cylindrical member 211 by the palm of the operator’s first hand. Thus, the actuator 213 is also referred to herein as a “lever” and/or a ”palm lever” for simplicity and ease of explanation of the illustrated examples. However, the actuator 213 can be any type of actuatable control that is actuatable in any direction relative to the cylindrical member 211 by the operator’s first hand, e.g., a button, a knob, a slider, etc. In some examples, the actuator 213 can be a sensor, e.g., a capacitive sensor, a temperature sensor, a pressure sensor, a light sensor, a proximity sensor, etc., coupled to the cylindrical member 211 and configured to detect contact between the operator’s first hand and the cylindrical member 211. In such examples, the operator can “actuate” the sensor by triggering the sensor with their first hand (e.g., with the palm of their first hand). In the illustrated example shown in FIGS. 2A-2B where the first control 210 is disposed left of the second control 220, the operator’s first hand can be the operator’s left hand. However, the first control 210 can alternatively be configured to be operated by the operator’s right hand, e.g., in examples where the first control 210 is located to the right of the second control 220.

As shown, the first control 210 is fixedly coupled to the surface 202 of the control panel 200 via a bracket 204 such that the cylindrical member 211 of the first control 210 cannot move relative to the surface 202. Fixedly coupling the cylindrical member 211 to the surface 202 helps provide a stable, non-moving structure on which the operator can rest their first hand. The first control 210 is shown as being fixedly coupled to a lateral edge portion of the surface 202 of the control panel 200, which beneficially prevents the bracket 204 from obstructing other controls or portions of the control panel 200. However, other examples of the first control 210 can be coupled to other portions of the surface 202.

The second control 220 is depicted in FIGS. 2A-2B as a button and is thus also referred to herein as a “button” solely for purposes of simplicity and ease of explanation of the illustrated examples. The second control 220 is configured to be actuated by the operator’s second hand. For example, the illustrated button 220 can be actuated by depressing the button 220 relative to the surface 202 of the control panel 200 by a finger of the operator’s second hand. In some examples, the second control 220 can be implemented as a different type of actuatable control, e.g., a switch, a knob, a lever, a slider, a touchscreen, etc. In some examples, the second control 220 can be a sensor, such as a capacitive sensor, a temperature sensor, a pressure sensor, a light sensor, a proximity sensor, etc., configured to detect the presence of the operator’s second hand, and the operator can “actuate” the sensor by triggering the sensor with their second hand. In the illustrated example of FIGS. 2A-2B where the second control 220 is disposed to the right of the first control 210, the operator’s second hand is the operator’s right hand. However, the second control 220 can alternatively be configured to be operated by the operator’s left hand, e.g., in examples where the second control 220 is located to the left of the first control 210.

The first and second controls 210, 220 are spaced apart from each other on the surface 202 of the control panel 200 such that the first and second controls 210, 220 cannot be simultaneously reached or operated by the same hand. For example, as shown, the first control 210 is spaced laterally apart from the second control 220 on the surface 202 of the control panel 200 by a lateral distance such that the operator cannot simultaneously reach or actuate both the first control 210 and the second control 220 using the same hand. In some examples, the first control 210 can be additionally or alternatively spaced vertically apart from the second control 220 by a vertical distance, and the horizontal distance, the vertical distance, and/or the combination thereof can be such that the operator cannot simultaneously reach or actuate both the first control 210 and the second control 220 using the same hand. Spacing the first and second controls 210, 220 apart from each other can help reduce the likelihood of inadvertently actuating both of the controls 210, 220. Additionally or alternatively, by configuring the controls 210 and 220 for use with two hands, this configuration of the control panel 200 can distance the operator standing behind the rear end portion 114 of the hydraulic machine 100 from the working implement 140 and any debris, e.g., flying wood chips, generated by the operation of the working implement 140.

The first control 210 and the second control 220 are configured to control (e.g., initiate or stop) one or more functions of the working implement 140. In the illustrated example where the hydraulic machine 100 is a stump grinder and the working implement 140 is the cutter wheel, the first and second controls 210, 220 can be configured to control (e.g., initiate or stop) a rotation of the cutter wheel 140. In some examples, the first control 210, the second control 220, and/or the combination thereof can be configured to control additional aspects of the functioning of the working implement 140. For example, the first control 210, the second control 220, and/or the combination thereof can be configured to control the direction of rotation and/or rotational speed of the cutter wheel 140.

The first and second controls 210, 220 are configured such that actuating both the first control 210 and the second control 220 initiates the function of the working implement, e.g., the rotation of the cutter wheel 140. In some examples, configuring the control system 160 to require the actuation of both the first and second controls 210, 220 can further reduce the likelihood of inadvertent initiation of the function of the working implement 140 because the likelihood of inadvertently actuating the two controls 210 and 220 is lower than the likelihood of actuating a single control.

In some examples, the control system 160 can be configured to require the actuation of the first and second controls 210, 220 in a particular order to initiate the function of the working implement 140. For example, the control system 160 can be configured such that the first control 210 must be actuated before the actuation of the second control 220 or vice versa in order to initiate the rotation of the working implement 140. In other examples, the control system 160 can be configured such that the first control 210 and the second control 220 must be actuated simultaneously in order to initiate the function of the working implement 140. In such examples, requiring a specific order of actuation can help further reduce the likelihood of an inadvertent initiation of the function of the working implement 140.

In some examples, the control system 160 can be configured such that the first and second controls 210, 220 can be actuated in any one of a plurality of different orders to initiate the function of the working implement 140. In such examples, configuring the control system 160 to allow the first and second controls 210, 220 to be actuated in any one of a plurality of different orders (e.g., any order) can simplify the operation of the control system 160 by allowing the operator to actuate the first and second controls 210, 220 in a sequence they find intuitive.

In some examples, the control system 160 can be configured such that releasing at least one of the first and second controls 210, 220 stops the function of the working implement 140. For example, the control system 160 can be configured such that releasing one or both of the first and second controls 210, 220 stops the function of the working implement 140. In some examples, the control system 160 can be further configured such that only the released control(s) must be re-actuated in order to resume the operation of the working implement 140. In some examples, the control system 160 can be further configured such that each one of the first control 210 and the second control 220 must be released and re-actuated in order to resume the operation of the working implement 140. In such examples, this configuration of the first and second controls 210, 220 can ensure that both of the operator’s hands are on the first and second controls 210, 220 while the cutter wheel 140 is rotating.

In some examples, the control system 160 can be configured such that releasing one of the first control 210 and the second control 220 while the working implement 140 is operating, e.g., when the cutter wheel 140 is rotating, does not stop the operation of the working implement 140 so long as the other one of the first control 210 and the second control 220 remains actuated. For example, the control system 160 can be configured such that the operator can release their second hand from the second control 220 after the cutter wheel 140 has started rotating without this release stopping the rotation of the cutter wheel so long as the first control 210 remains actuated, e.g., depressed, by the operator’s first hand. This configuration of the first and second controls 210, 220 can beneficially reduce finger fatigue by eliminating the need to depress the finger-actuated second control 220 over long periods of time. Additionally, configuring the second control 220 to be releasable without stopping the operation of the working implement 140 can free the operator’s second hand to operate other controls without stopping the operation of the working implement 140. For example, the operator can use their second hand to operate the fourth control 240 to control the arm 130, e.g., to sweep the arm 130 and the working implement 140 leftward and rightward, without stopping the operation of the working implement 140. Alternatively, the operator can use their second hand to operate the fifth control 250 and/or the sixth control 260 to operate the drive assembly 120 and move the hydraulic machine 100 across the ground (e.g., closer to a tree stump) without stopping the operation of the working implement 140.

FIGS. 3-4 depict various aspects of the first control 210, which is depicted as and also referred to herein as a “palm switch assembly” solely for purposes of simply explaining the illustrated examples. As shown, the palm switch assembly 210 includes the cylindrical member 211, the actuator 213 coupled to the cylindrical member 211, a first pin 215 pivotally coupling the cylindrical member 211 and the actuator 213, an electrical switch 217 disposed within the cylindrical member 211, and a spring 218 coupled to the cylindrical member 211 and the actuator 213. In some examples, the palm switch assembly 210 can optionally include a second pin 219 configured to limit the travel of the actuator 213 relative to the cylindrical member 211.

The cylindrical member 211 (which is also referred to herein as a “palm rest,” a “handle,” and/or a “body” of the palm switch assembly 210) is a portion of the palm switch assembly 210 configured to support at least a portion of the operator’s first hand while the operator rests their first hand on the palm switch assembly 210. The cylindrical member 211 is depicted as a cylindrical body but can be implemented in other shapes (e.g., a semi-cylindrical body). As shown, the cylindrical member 211 includes a slot 212 extending along a length (e.g., a partial length) of the cylindrical member 211. The slot 212 can be sized and shaped to accommodate at least a portion of the actuator 213 therein, i.e., such that the actuator 213 can be at least partially disposed within the slot 212. In some examples, the slot 212 can be sized such that the actuator 213 at least partially protrudes from the slot 212 when the actuator 213 is in an un-actuated position and such that the actuator 213 is disposed fully within the slot 212, i.e., does not protrude from the slot 212, when the actuator 213 is in a fully actuated position.

The actuator 213 (which is also referred to herein as a “palm lever” and/or a “lever”) is a structure configured to be actuated, e.g., pivoted, relative to the cylindrical member 211 by the palm of the operator’s first hand. The actuator 213 is depicted as a lever that is pivotally coupled to the cylindrical member 211 via the first pin 215. However, the actuator 213 can be any type of actuatable control that is actuatable in any direction relative to the cylindrical member 211 by the palm of the operator’s first hand, e.g., a button, a knob, a slider, etc. In some examples, the actuator 213 can be a sensor, e.g., a capacitive sensor, a temperature sensor, a pressure sensor, a light sensor, a proximity sensor, etc., coupled to the cylindrical member 211 and configured to detect contact between the palm of the operator’s first hand and the cylindrical member 211, and the operator can “actuate” the sensor by triggering the sensor with the palm of their first hand.

As shown, the actuator 213 includes a palm-engaging portion 213a and a switch-engaging portion 213b. The actuator 213 is configured such that a force exerted on the palm-engaging portion 213a, e.g., a force exerted by the palm of an operator’s first hand on the palm-engaging portion 213a, causes the actuator 213 to pivot about the first pin 215 toward the cylindrical member 211. As the actuator 213 is pivoted to its actuated position, the switch-engaging portion 213b comes into contact with the electrical switch 217 disposed within the cylindrical member 211. As discussed later herein with respect to FIG. 5, the electrical switch 217 is electrically coupled to a first valve 342 (FIG. 5) that at least partially controls the flow of hydraulic fluid to the motor 146, and the hydraulic machine 100 is configured such that engaging the electrical switch 217 opens or closes the first valve 342.

In some examples, the electrical switch 217 can be configured to be actuated between an “on” position in which current flows through the electrical switch 217 and an “off” position in which current does not flow through the electrical switch 217. In such examples, the hydraulic machine 100 can be configured such that engaging the electrical switch 217 to the “on” position either fully opens or fully closes the first valve 342.

In some examples, the electrical switch 217 can be a variable electrical switch, e.g., a potentiometer, configured to be actuatable to any one of a plurality of “on” positions. In such examples, the first valve 342 can be an adjustable flow valve configured to be actuatable to any one of a plurality of open positions corresponding to the plurality of “on” positions of the electrical switch 217. The first valve 342 can have different flow rates in each of the plurality of open positions. The hydraulic machine 100 can be configured such that engaging the electrical switch 217 to one of the plurality of “on” positions opens the first valve 342 to the corresponding one of the open positions (or to a corresponding percentage of the fully open position). In such configurations, the actuator 213 can function as a speed control for the working implement 140, with movement of the actuator 213 increasing or decreasing the flow of hydraulic fluid to the motor that rotates the working implement according to the position of the actuator 213.

The spring 218 is configured to bias the actuator 213 to the non-actuated position in which the switch-engaging portion 213b of the actuator 213 does not engage the electrical switch 217. In some examples, biasing the actuator 213 to its non-actuated position can help ensure that the actuator 213 promptly disengages the electrical switch 217 (and thus promptly stops the operation of the working implement 140) when the actuator 213 is released by the operator’s first hand.

In some examples, the actuator 213 can optionally further include a slot 214 configured to limit the travel of the actuator 213 relative to the cylindrical member 211. As shown, the slot 214 of the actuator 213 is disposed on a portion of the actuator 213 substantially opposite the actuator’s switch-engaging portion 213b. The optional second pin 219 can be mounted to the cylindrical member 211 and can extend at least partially through the slot 214. The slot 214 and the second pin 219 can cooperate to limit the travel distance of the actuator 213 to the length of the slot 214. In some examples, the first control 210 can omit the slot 214 and the second pin 219.

Now referring back to FIGS. 2A-2B, the third control 230 and the fourth control 240 are “arm controls” configured to control one or more functions of the arm 130. For example, the third control 230 can be configured to control vertical movement, e.g., raising or lowering, of the arm 130 relative to the chassis 110, and the fourth control 240 can be configured to control horizontal movement, e.g., a leftward or rightward sweep, of the arm 130 relative to the chassis 110. In some examples, the functions of the third control 230 and the fourth control 240 can be switched (e.g., such that the third control 230 controls the horizontal sweep of the arm 130). In some examples, the third and/or fourth controls 230, 240 can be configured to control different functions of the arm 130, e.g., a longitudinal movement of the arm 130 in the longitudinal direction.

As shown, the third control 230 is a lever (which is also referred to herein as a “lift lever”) configured to be actuated in a fore-aft direction perpendicular to the lateral direction. However, the third control 230 can alternatively be configured to be actuated in a different direction, e.g., in the lateral direction. Alternatively, the third control 230 can be implemented as any other type of actuatable control, e.g., a knob, a button, a slider, a touchscreen, etc.

As further shown, the third control 230 is spaced sufficiently close to the first control 210 such that the first control 210 and the third control 230 can be simultaneously actuated by the same hand. This configuration can allow the operator to at least partially control the arm 130 without stopping the operation of the working implement 140. As shown, the third control 230 is at least partially aligned in the lateral direction with the first control 210. The illustrated relative positions and/or alignment of the first and third controls 210, 230 can allow the operator to actuate the third control 230 using at least one finger of their first hand while the palm of the operator’s first hand is in contact with the first control 210, e.g., while the palm of the operator’s first hand is depressing the actuator 213. The third control 230 can comprise a grip portion 232 (which is also referred to herein as a “fingerhold”) configured to be engaged by the at least one finger of the operator’s first hand while the palm of the operator’s first hand is in contact with the first control 210. As shown, the grip portion 232 extends in a direction substantially parallel to the length of the palm rest 211 of the first control 210, thereby allowing the operator to more securely engage the third control 230 with multiple fingers, e.g., instead of a single finger.

As shown, the fourth control 240 is a lever (which is also referred to herein as a “sweep lever”) configured to be actuated in the lateral, e.g., left-right, direction. In some examples, operators associating the lateral direction with the lateral sweep of the arm 130 may find this configuration intuitive. However, the fourth control can be alternatively can be configured to be actuated in a different direction, e.g., the fore-aft direction. The fourth control 240 can be implemented as any other type of actuatable control, e.g., a knob, a button, a slider, a touchscreen, etc. As shown, the fourth control 240 is spaced laterally apart from the first and third controls 210, 230. The fourth control 240 can be configured to be actuated by the operator’s second hand, which allows the operator to simultaneously operate the first and/or third controls 210, 230 with their first hand (e.g., their left hand) and the fourth control 240 with their second hand (e.g., their right hand).

In some examples, the control system 160 can include one or more actuators (e.g., buttons, triggers, levers, etc.) configured such that the combined actuation of one or more of the third and fourth controls 230, 240 and the actuator initiates a function (e.g., movement) of the arm 130. In some examples, the actuator can be spaced apart on the control panel 200 from the third and fourth controls 230, 240. In some examples, the actuator can be included on one of the third or fourth controls 230, 240. For example, the third control 230 can be a lever including a palm-actuatable actuator, e.g., a palm-depressible lever similar to actuator 213, and the control system 160 can be configured such that moving the third control 230 and depressing the palm-actuatable actuator initiates vertical movement of the arm 130. Additionally or alternatively, the fourth control 240 can be a lever, and can include an actuator configured such that moving the fourth control 240 and actuating the actuator initiates horizontal movement of the arm 130.

The fifth control 250 and the sixth control 260 are “drive assembly controls” configured to control one or more functions of the drive assembly 120. As shown, the fifth and sixth controls 250, 260 are levers (which are also referred to herein as “drive levers”) configured to control a forward or reverse motion of a respective one of the tracks 122 of the drive assembly 120. For example, the fifth control 250 can be a lever controlling the forward or reverse motion of a left track 122 and the sixth control 260 can be a lever controlling the forward or reverse motion of a right track 122. The fifth and sixth controls 250, 260 can be actuated to different degrees to turn the hydraulic machine 100 via differential steering. As further shown, the fifth and sixth controls 250, 260 are spaced laterally apart from the first, second, third, and fourth controls 210, 220, 230, 240, thereby allowing the fifth and sixth controls 250, 260 to be actuated by the operator’s second hand.

In some examples, the control system 160 can include one or more actuators (e.g., buttons, triggers, levers, etc.) configured such that the combined actuation of one or more of the fifth and sixth controls 250, 260 and the actuator initiates a function of the drive assembly 120. In some examples, the actuator can be spaced apart on the control panel 200 from the fifth and sixth controls 250, 260. In some examples, the actuator can be included on one of the fifth and sixth controls 250, 260. For example, the fifth control 250 can be a lever including a palm-actuatable actuator, e.g., a palm-depressible lever similar to actuator 213, and the control system 160 can be configured such that moving the fifth control 250 and depressing the palm-actuatable actuator initiates a forward or reverse motion of the left track 122. Additionally or alternatively, the sixth control 260 can include an actuator configured such that actuating both the sixth control 260 and the actuator initiates a motion of the right track 122.

FIG. 5 schematically depicts various aspects of a hydraulic circuit 300 of the hydraulic machine 100. As shown, the hydraulic circuit 300 includes the pump 310 in fluid connection with a left track loop 320a, a right track loop 320b, an arm loop 330, and a working implement loop 340. As used herein, the term “loop” refers to portions of the hydraulic circuit 300 that include one or more hydraulic components in fluid connection with each other. Example hydraulic components can include pumps, valves (e.g., solenoid valves, pressure relief valves, check valves, one-way valves), motors, actuators, heat exchangers, pressure sensors, etc. Each loop defines one or more fluid flow paths for hydraulic fluid flowing through the loop. In some examples, the fluid flow path through the loop can change depending on a state of one or more hydraulic components (e.g., depending on whether a valve is opened or closed).

It should be understood that the hydraulic circuit 300 includes conduits configured to fluidly connect the various hydraulic components in the illustrated arrangement, and although the conduits are shown in FIG. 5, the conduits are not expressly labeled or described solely in order to simplify the illustration and description of the disclosed technology.

The pump 310 is mechanically coupled to and is powered by the engine assembly 150. In some examples, the pump 310 can include a plurality of pumps. In such examples, each one of the plurality of pumps can supply hydraulic fluid to a different loop or a different combination of loops. In some examples, the plurality of pumps can be connected in parallel to supply hydraulic fluid to the same loop or same combination of loops.

The left track loop 320a and the right track loop 320b are configured to supply pressurized hydraulic fluid to left and right portions of the drive assembly 120. For example, the left track loop 320a can be configured to supply hydraulic fluid to a left motor 322a configured to impart torque on a left drive wheel 124, and the right track loop 320b can be configured to supply hydraulic fluid to a right motor 322b configured to impart torque on a right drive wheel 124. The rotation of the left and right drive wheels 124 causes the rotation of the left and right tracks 122, respectively. In some examples, the left track loop 320a can be configured to supply a first amount of hydraulic fluid (e.g., at a first pressure or at a first flow rate) to the left motor 322a, and the right track loop 320b can be configured to supply a second amount of hydraulic fluid (e.g., at a second pressure or at a second flow rate). A difference in the quantities and/or pressures of the hydraulic fluid supplied to the two hydraulic motors 322a, 322b can cause the hydraulic machine 100 to turn left or right via differential steering.

The arm loop 330 is configured to supply pressurized hydraulic fluid to one or more hydraulic cylinders 139 configured to move the arm 130 relative to the chassis 110. For example, the arm loop 330 can be configured to supply pressurized hydraulic fluid to a first hydraulic cylinder 139a configured to move the arm 130 vertically relative to the chassis 110, and/or second and third hydraulic cylinders 139b, 139c. The second hydraulic cylinder 139b and the third hydraulic cylinder 139c can be configured to cooperate such that the combined actuation of the second and third hydraulic cylinders 139b, 139c moves, e.g., sweeps, the arm 130 laterally, e.g., left or right. In some examples, the hydraulic machine 100 can include only one of the second and third hydraulic cylinders 139b, 139c.

The working implement loop 340 is configured to supply pressurized hydraulic fluid to the motor 146 coupled to the working implement 140. The flow of hydraulic fluid through the motor 146 causes the motor 146 to actuate the working implement 140, e.g., rotate the cutter wheel 140. The working implement loop 340 fluidly connects the motor 146 to a first valve 342, a second valve 344, a third valve 346, and a fourth valve 348.

As shown, the first valve 342 is a normally open solenoid valve connected in parallel with the motor 146. The first valve 342 includes an inlet upstream of the motor 146 and an outlet downstream of the motor 146. The first valve 342 is switchable between a de-energized state and an energized state. The normally open first valve 342 is configured such that hydraulic fluid can flow from the inlet to the outlet, thereby bypassing the motor 146, when the first valve 342 is in the de-energized state. In other words, the first valve 342 is “open” in the de-energized state.

The first valve 342 is electrically coupled to the electrical switch 217 of the first control 210 such that actuating the actuator 213, e.g., depressing the lever 213, relative to the cylindrical member 211 and causing the switch-engaging portion 213b of the actuator 213 to engage the electrical switch 217 causes the first valve 342 to transition from the open, de-energized state to a closed, energized state, thereby preventing the flow of hydraulic fluid through the first valve 342.

As shown, the second valve 344 can be a pilot-assisted relief valve connected in series with the motor 146. The second valve 344 is switchable between a de-energized state and an energized state. In the de-energized state, the second valve 344 is configured such that hydraulic fluid cannot flow through the second valve 344. In the energized state, the second valve 344 is configured such that hydraulic fluid can flow through the second valve 344. The second valve 344 is electrically coupled to the second control 220 such that actuating the second control 220, e.g., depressing the button 220 shown in FIGS. 2A-2B, causes the second valve 344 to transition from the de-energized state to the energized state.

As shown, the third valve 346 can be a check valve connected in parallel with the second valve 344. The second and third valves 344, 346 can together define a counterbalance valve assembly configured to regulate the pressure of the hydraulic fluid downstream of the motor 146.

As shown, the fourth valve 348 can be a pressure relief valve connected in parallel with the motor 146 and the first valve 342. The fourth valve 348 can be configured to reduce overpressure of the hydraulic fluid in the working implement loop 340.

The first valve 342 and the second valve 344 are collectively configured to at least partially control the flow of hydraulic fluid through the motor 146. For example, the first valve 342 and the second valve 344 are fluidly connected to the motor 146 such that hydraulic fluid will only flow through the motor 146 if both the first valve 342 and the second valve 344 are each in their respective energized states. Thus, this configuration of the working implement loop 340 requires the actuation of both the first control 210 (coupled to the first valve 342) and the second control 220 (coupled to the second valve 344) in order to initiate the flow of hydraulic fluid through the motor 146.

In another example, the control system 160 can include a timer associated with the actuator 213. The timer can be configured to allow the working implement 140 to be restarted if the actuator 213 is in the un-actuated position for a selected time period (e.g., two seconds or less). This can allow a user to quickly and temporarily release the actuator 213 without having to engage the second control 220 to restart the working implement 140.

Although portions of the present disclosure describe the first and second controls 210, 220 as being configured to control the rotation of the cutter wheel 140, such portions are not intended to be limiting. Thus, it should be understood that the first and second controls 210, 220 can be configured to control other types of functions of other types of working implements 140 in examples where the working implement 140 is not a cutter wheel and the hydraulic machine 100 is not a stump grinder.

### Additional Examples of the Disclosed Technology

Although portions of the present disclosure describe implementing the control system 160, the control panel 200, and the controls 210, 220, 230, 240, 250, 260 on a stump grinder, it should be understood that such portions are not intended to be limiting. Thus, it should be understood that the control system 160, control panel 200, and controls 210, 220, 230, 240, 250, 260 are compatible with and can be implemented on any other hydraulic machine, e.g., any one of the hydraulic machines listed herein.

The above description of the control system 160, the control panel 200, and the controls 210, 220, 230, 240, 250, 260 is not intended to be limiting, and it should be understood that the controls 210, 220, 230, 240, 250, 260, or any subsets thereof, can be arranged in any combination, in any layout described herein, and/or in any combination of such layouts. It should also be understood that any control of the control system 160 can be configured to include any combination of functionalities of the controls 210, 220, 230, 240, 250, 260 and that the functionalities of the controls 210, 220, 230, 240, 250, 260 can be divided among any number of actuators (e.g., levers, joysticks, buttons, switches, touchscreens, etc.).

For example, the functionality of the third control 230 and/or the fourth control 240 can be implemented on other controls, e.g., any one or combination of the first control 210, the second control 220, the fifth control 250, and/or the sixth control 260. For example, the first control 210 can include one or more actuators, e.g., buttons, sliders, knobs, triggers, levers, etc., configured to implement the functionality of the third controls 230 and/or the fourth control 240, i.e., control movement of the arm 130. In such examples, this configuration can allow the operator to operate the arm 130 and the working implement 140 with one hand.

In some examples, the functionality of the fifth control 250 and/or the sixth control 260 can be implemented on other controls, e.g., any one or combination of the first control 210, the second control 220, the third control 230, and the fourth control 240. For example, the first control 210 can include one or more actuators, e.g., buttons, sliders, knobs, triggers, levers, etc., configured to implement the functionality of the fifth control 250 and/or the sixth control 260, i.e., control the operation of the drive assembly 120. In such examples, this configuration can allow the operator to move the hydraulic machine 100 across the ground without stopping the working implement 140.

In some examples, any functionality or combination of functionalities of the controls 210, 220, 230, 240, 250, 260 can be incorporated into one or more joysticks. The joysticks can be configured to be actuated in any direction or combination of directions, e.g., the fore-aft direction and/or the left-right direction. For example, the functionality of the third control 230 and the fourth control 240 can be incorporated into a joystick, configured to be actuated in the fore-aft direction and the left-right direction to move the arm 130 vertically and horizontally, respectively. In some of these examples, the joystick can be spaced laterally apart from the first control 210 and can be configured to be operated by the operator’s second hand. In some examples, the joystick can also be spaced apart, e.g., in the lateral direction, from the second control 220. In some examples, the controls that start and stop the working implement 140 are not on the joystick. In some examples, the functionality of the first control 210 can be implemented on the joystick (e.g., with a button, a trigger, a lever, etc.) and the second control 220 can be on the control panel 200 spaced apart from the joystick (e.g., to the left, right, above, or below the joystick). In another example, the functionality of the second control 220 can be implemented on the joystick (e.g., with a button, a trigger, a lever, etc.) and the first control 210 can be on the handle 211 and spaced apart from the joystick. In some examples, the functionality of both the first control 210 and the second control 220 can be implemented on the joystick. For example, the joystick can include a trigger implementing the functionality of one of the first control 210 or the second control 220 and a button implementing the functionality of the other one of the first control 210 or the second control 220. In some examples, the button and the trigger can be on opposite sides of the joystick, such that the trigger can be actuated by the index finger of the operator’s hand and the button can be depressed by the thumb of the operator’s hand.

In some examples, the functionality of the fifth control 250 and the sixth control 260 can additionally or alternatively be incorporated into a joystick configured to be actuated in the fore-aft direction and the left-right direction to move the hydraulic machine 100 across the ground. In some of these examples, the joystick can be spaced laterally apart from the first control 210 and can be configured to be operated by the operator’s second hand. In some examples, the controls that start and stop the working implement 140 are not on the joystick. In some examples, the functionality of both the first control 210 and the second control 220 can be implemented on the joystick. For example, the joystick can include a trigger implementing the functionality of one of the first control 210 or the second control 220 and a button implementing the functionality of the other one of the first control 210 or the second control 220. In some examples, the button and the trigger can be on opposite sides of the joystick, such that the trigger can be actuated by the index finger of the operator’s hand and the button can be depressed by the thumb of the operator’s hand.

In some examples, the control system 160 can include a first joystick and a second joystick. The first and second joysticks can be configured to implement the functionality of any combination of the first, second, third, fourth, fifth, and/or sixth controls 210, 220, 230, 240, 250, 260. For example, the first joystick can be configured to include the functionality of the arm controls such that fore-aft and leftward-rightward movements of the first joystick initiate different functions, e.g., movements, of the arm 130. The second joystick can be configured to include the functionality of the drive assembly controls such that fore-aft movement of the second joystick initiates a forward or reverse motion of the drive assembly 120, and a leftward-rightward movement of the second joystick initiates a leftward or rightward turn. In some examples, each one of the first and second joysticks can be configured to implement at least some functionality of the arm controls and at least some functionality of the drive assembly controls; for example, fore-aft movement of the first joystick can initiate forward or reverse motion of the drive assembly 120 and leftward-rightward movement of the first joystick can initiate horizontal movement of the arm 130.

In some examples, the functionality of the first control 210 can be implemented on the first joystick and the functionality of the second control 220 can be implemented on the second joystick, or vice versa. For example, the first joystick can include a first actuator (e.g., a button, trigger, slider, lever, etc.) configured to implement the functionality of the first control 210 and the second joystick can include a second actuator configured to implement the functionality of the second control 220. In some examples, one of the first joystick and the second joystick includes two actuators that implement the functionality of the first and second controls 210, 220.

In some examples, the functionality of any one or combination of controls 210, 220, 230, 240, 250, 260 can be incorporated into a foot-actuatable control, e.g., a foot pedal. The foot-actuatable control is not disposed on the control panel 200 and can instead be disposed on a lower portion of the rear end portion 114 of the chassis 110, e.g., on a floor or platform beneath the control panel 200. In some examples, the functionality of the first control 210 can be incorporated into the foot-actuatable control, and the hydraulic machine 100 can be configured such that actuating both the foot-actuatable control disposed beneath the control panel 200 at the rear end portion 114 of the chassis 110 and the second control 220 disposed on the control panel 200 initiates the function of the working implement 140. In some examples, the functionality of the second control 220 can be incorporated into the foot-actuatable control, and the hydraulic machine 100 is configured such that actuating both the first control 210 disposed on the control panel 200 and the foot-actuatable control beneath the control panel 200 initiates the function of the working implement 140. In some examples, the foot-actuatable control can be configured or positioned such that the foot-actuatable control can be reached and/or actuated by an operator standing on a platform mounted to the rear end portion 114 of the chassis. In some examples, after the working implement 140 is activated, the working implement 140 can continue to function while the foot pedal remains depressed. In some examples, the foot pedal can be configured to operate as a variable speed control for the working implement 140 in which the position of the pedal relative to the platform varies the flow of hydraulic fluid to the motor 146 coupled to the working implement 140. In these examples, configuring the controls to be operated by different appendages (e.g., a hand and a foot) of the operator’s body can help further reduce the likelihood of an inadvertent initiation of the function of the working implement 140.

Although portions of the present disclosure describe the first control 210 primarily with reference to the illustrated examples, it should be understood that such portions are not intended to be limiting and the first control 210 can include additional or alternative features and/or different combinations of features.

In some examples, the cylindrical member 211 can lack the slot 212 and the actuator 213 can be external to the cylindrical member 211 in both the actuated position and un-actuated position. For example, the actuator 213 can be coupled, e.g., pivotally coupled, to an exterior of the cylindrical member 211 such that the actuator 213 can pivot about a location external to the cylindrical member 211. In some examples, the actuator 213 can be configured as a lever pivotably coupled to the handle 211 at one end by a mounting bracket and spaced outwardly away from the handle 211 in the manner of a bicycle or motorcycle handbrake. In such configurations, actuation of the actuator can be with the fingers of the user’s first hand.

In some examples, the first control 210 can include a hand guard that at least partially covers the actuator 213. In some of these examples, the hand guard can also at least partially cover the cylindrical member 211. The first control 210 can include a gap between the hand guard and the actuator 213 and/or between the hand guard and the cylindrical member 211 such that the operator must insert their first hand into the gap in order to rest their hand on the cylindrical member 211 and/or actuate the actuator 213. In these examples, the hand guard can further reduce the likelihood of inadvertent actuation of the actuator 213.

In some examples, the first control 210 can include a plurality of actuators. For example, the first control 210 can include a first actuator (e.g., the actuator 213) and a second actuator. In some examples, the second actuator can be a sensor configured to detect the presence of the operator’s first hand on the first control 210. In some examples, the second actuator can be a flap that is moveable relative to the cylindrical member 211. The flap and the cylindrical member 211 can define a gap therebetween, and the flap is configured such that inserting the operator’s first hand into the gap between the flap and the cylindrical member 211 actuates the flap. In some examples, the flap can be configured as a relatively stiff plate such as a handguard. In some examples the flap can comprise a flexible material such as fabric or rubber. In some of these examples, the first control 210 can be configured such that actuating one or more of the plurality of actuators activates the first control 210 (e.g., allows the first control 210 to transmit a signal to the controller to rotate the cutter wheel 140). In some examples, the first control 210 can be configured such that it is activated only if each of the plurality of actuators are actuated. For example, the first control 210 can be configured such that the actuator 213 is activated and able to transmit a signal to the controller only when the flap is actuated, which indicates that the operator is grasping the handle 211 of the first control 210 in a specified manner. Alternatively, the controller can be configured to act on a signal from the actuator 213 only when a signal is received from the flap indicating that the operator is gripping the handle 211.

At least some of the control systems described herein can provide one or more of the following advantages, such as providing a more ergonomic configuration of controls for hydraulic machines.

In some examples, the disclosed control systems can reduce the amount of finger fatigue experienced by the operator because the operator does not have to pull and hold down a trigger with their finger during the duration of a stump grinding process.

In some examples, the disclosed control systems allow the operator to rest their first hand on the palm rest while depressing the actuator, which requires very little effort on the part of the operator and is a naturally held position of the operator’s first hand while grinding a tree stump.

In some examples, the disclosed control systems free the operator’s second hand from the sweep lever to move the drive assembly controls to position the hydraulic machine further into a tree stump without having to start and stop the cutter wheel.

In some examples, the disclosed control systems position the second control in a location on the control panel to be easily activated with the operator’s second hand either after or before the first control is actuated.

In some examples, the nature of the disclosed control systems facilitates intuitive explanation of the operation of the machine by equipment rental companies.

In some examples, the disclosed control systems can provide certain additional safety advantages.

In some examples, the disclosed control systems require the operator to stay at the rear of the machine with both hands on the controls, thereby keeping the operator away from the cutter wheel and any inadvertent flying wood chips.

### Example #2 of the Disclosed Technology

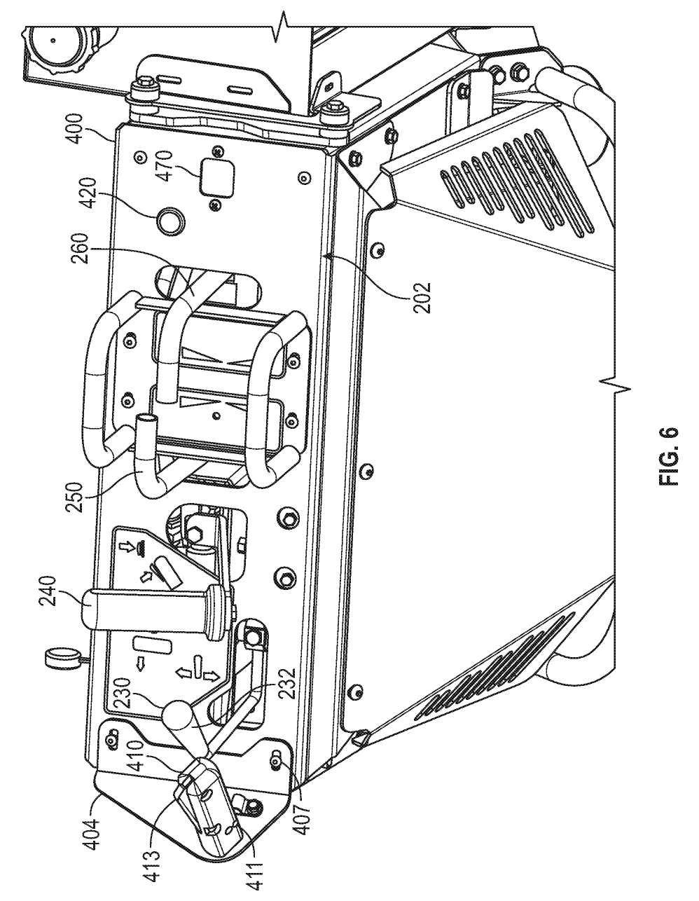

FIG. 6 depicts various aspects of a control panel 400 of a control system of a hydraulic machine, according to another example. Similar to the control panel 200 (FIGS. 2A-2B), the control panel 400 can be configured to facilitate operation of the drive assembly 120, the arm 130, and/or the working implement 140 of the hydraulic machine 100. Thus, in some examples, the control system 160 of the hydraulic machine 100 can include the control panel 400 instead of the control panel 200.

As shown in FIG. 6, the control panel 400 defines the surface 202 oriented upwardly and rearwardly toward the operator. As further shown, the control panel 400 includes a plurality of controls arranged on or extending through the surface 202. The plurality of controls includes a first control 410 and a second control 420, which are collectively referred to herein as “working implement controls” and are configured to control one or more functions of the working implement 140. The control panel 400 further includes the third control 230, the fourth control 240, the fifth control 250, and the sixth control 260. In some examples, the control panel 400 can include additional controls, e.g., an ignition switch to start the engine of the hydraulic machine. Although the illustrated control panel 400 includes a blank-off plate 470 instead of an ignition switch, some examples of the control panel 400 can include the ignition switch installed at the location of blank-off plate 470. In some examples, the control panel 400 can include one or more indicators (e.g., dials, lights, and/or screens) configured to display a status of the hydraulic machine 100 to the operator.

As shown in FIG. 6, the first control 410 (which is also referred to herein as a “palm switch assembly”) is a palm-actuated switch assembly. The first control 410 can share certain similar features with the first control 210 (FIGS. 2A-4). For example, the first control 410 can include a handle member 411, an actuator 413 coupled to the handle member 411, and a bracket 404 configured to couple the handle member 411 to the surface 202 of the control panel 400.

The handle member 411 (which is also referred to has a “palm rest,” a “palm rest member,” and and/or a “handle”) is configured to support at least a portion of the operator’s first hand, e.g., a palm of the operator’s first hand, when the operator rests their first hand on the first control 410. The handle member 411 can share certain similar features with the cylindrical member 211 (FIGS. 2A-4). One exemplary difference between the handle member 411 and the cylindrical member 211 is that the handle member 411 has a non-cylindrical shape, e.g., a shape including a combination of flat or squared-off sides and curved length-wise sides. In some examples, configuring the handle member 411 to include one or more flat or squared-off length-wise sides can allow the operator to more ergonomically grasp the handle member 411 during operation. However, in some examples, the handle member 411 can have a cylindrical shape similar to the shape of cylindrical member 211.

In some examples, the handle member 411 can have an adjustable length; thus, in such examples, the handle member 411 can also be referred to herein as a “length-adjustable” handle member. For example, the length-adjustable handle member 411 can have an extendable body or a telescoping body, thereby allowing the operator to configure the length-adjustable handle member 411 to more comfortably or ergonomically accommodate the operator’s first hand. The telescoping body can include an outer sleeve moveable in the length-wise direction relative to an inner sleeve. In some of these examples, the outer sleeve can be further configured to rotate about a centerline of the handle member 411 relative to the inner sleeve, thereby permitting rotational adjustment of the handle member 411. In yet further examples, at least one spacer can be coupled to the handle member 411 to increase the effective length of the handle member 411. For example, the spacer can be coupled between the bracket 404 and the handle member 411 or coupled to an end of the handle member 411 opposite the bracket 404. In yet further examples, the handle member 411 can additionally or alternatively have other adjustable dimensions (e.g., a width, a curvature, or a diameter), thereby allowing the operator to further configure the handle member 411 to accommodate the operator’s first hand.

The actuator 413 (which is also referred to herein as a “palm lever” and/or a “lever”) is a structure configured to be actuated, e.g., pivoted, relative to the handle member 411 by the palm of the operator’s first hand. The actuator 413 can share certain similar features with the actuator 213 (FIGS. 2A-4). For example, the actuator 413 can be a lever that is pivotally coupled to the handle member 411. However, the actuator 413 can be any type of actuatable control that is actuatable in any direction relative to the handle member 411 by the palm of the operator’s first hand, e.g., a button, a knob, a slider, etc. In some examples, the actuator 413 can be a sensor, e.g., a capacitive sensor, a temperature sensor, a pressure sensor, a light sensor, a proximity sensor, etc., coupled to the handle member 411 and configured to detect contact between the palm of the operator’s first hand and the handle member 411, and the operator can “actuate” the sensor by triggering the sensor with the palm of their first hand. In yet other examples, the actuator 413 can include a combination of a mechanical switch (e.g., a lever, a button, etc.) and an electrical sensor (e.g., a capacitive sensor, pressure sensor, etc.).

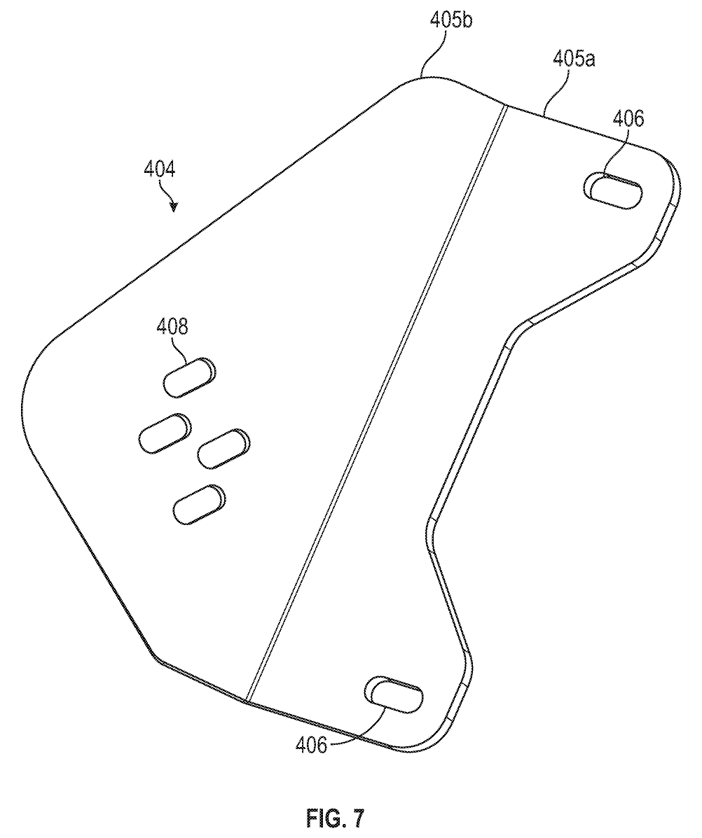

Now referring to FIG. 7, the bracket 404 (which is also referred to herein as a “mounting bracket,” a “plate,” and/or a “mounting plate”) is configured to couple the handle member 411 to the surface 202 of the control panel 400. The bracket 404 can share certain similar features with the bracket 204 (FIGS. 2A-4). As shown, the bracket 404 includes one or more first holes 406, e.g., a plurality of first holes 406. Each first hole 406 is configured to receive a corresponding fastener 407 (FIG. 6) therethrough, wherein the fastener 407 is configured to couple the bracket 404 to the surface 202 of the control panel 400. In some examples, each one of the plurality of first holes 406 can be a slotted hole oriented in the lateral direction of the hydraulic machine, thereby allowing the operator to couple the bracket 404 (and the handle member 411 coupled thereto) to the surface 202 at any one of a plurality of lateral positions along the length of the slotted first holes 406 relative to the third control 230. In some examples, the plurality of first holes 406 can be slotted holes oriented in another direction, thereby allowing the operator to couple the bracket 404 to the surface 202 at any one of a plurality of positions along the lengths of the slotted first holes 406 in the other direction. Thus, the plurality of first holes 406 can allow the operator to adjust the position of the handle member 411 relative to the third control 230 (e.g., relative to the grip portion 232 of the third control 230) to achieve a more comfortable and/or more ergonomic configuration that allows the operator’s first hand to engage both the first control 410 and the third control 230.

The bracket 404 includes a laterally extending flange 405a and an upwardly extending flange 405b. One exemplary difference between the bracket 404 and the bracket 204 (FIGS. 2A-2B) is that the bracket 404 includes at least one second hole 408, e.g., a plurality of second holes 408 at different locations on the upwardly extending flange 405b of the bracket 404 as shown in FIG. 7. The first control 410 can include at least one fastener that is configured to be inserted through a selected second hole 408 to couple the handle member 411 to the bracket 404. Since each second hole 408 corresponds to a different position of the handle member 411 relative to the third control 230, the plurality of second holes 408 allows the operator to adjust the position of the handle member 411 relative to the third control 230. Accordingly, the handle member 411 can also be referred to herein as a “positionally adjustable” handle member.

Furthermore, in examples where one or more of the second holes 408 are slotted holes, the positionally adjustable handle member 411 can be coupled to the bracket 404 at a selected one of a plurality of positions along the length of any one of the slotted second holes 408, thereby allowing the operator to further adjust the position of the handle member 411 relative to the grip portion 232 of the third control 230. However, it should be understood that the plurality of second holes 408 can be round holes, slotted holes, or a combination thereof.

In some examples, the handle member 411 can be coupled to the bracket 404 at a selected one of a plurality of rotational positions relative to the bracket 404, relative to the third control 230, and/or relative to the rest of the control panel 400. Accordingly in such examples, the handle member 411 can also be referred to herein as a “rotationally adjustable” handle member. In some examples, the handle member 411 can be fastened to the bracket 404 and can be rotatable to a selected one of a plurality of different rotational positions. In some examples, the first control 410 can include a pivot or a hinge configured to permit rotation of the handle member 411. For example, the bracket 404 can include a hinge disposed between the laterally extending flange 405a and the upwardly extending flange 405b that allows the upwardly extending flange 405b and the handle member 411 to rotate in unison relative to the laterally extending flange 405a and/or the third control 230, both of which are fixed to the surface 202 of the control panel 400. In some examples, the handle member 411 can be configured to rotate around the fastener that couples the handle member 411 to the bracket 404. For example, the handle member 411 can include an internal bearing or other structure that permits rotation of the handle member 411 around the fastener. In some examples, the first control 410 can include a first fastener configured to couple the handle member 411 to the bracket 404, and the handle member 411 can be configured to rotate around the first fastener. In some of these examples, the first fastener can be aligned with the centerline of the handle member 411 such that the handle member 411 is configured to rotate about its centerline. In yet further examples, the first control 410 can include a second fastener coupled to the handle member 411 at a location offset from the first fastener and/or the centerline of the handle member 411. The second fastener can be configured to extend through a curved slot in the bracket 404 and travel along the length of the curved slot as the handle member 411 rotates around the first fastener relative to the bracket 404. In some examples, configuring the handle member 411 to be rotationally adjustable, e.g., relative to the third control 230, can allow the operator to orient the handle member 411 such that the operator’s first hand can comfortably and/or ergonomically engage both the actuator 413 of the first control 410 and the grip portion 232 of the third control 230.

In some examples, the handle member 411 can be configured to be any combination of length adjustable, positionally adjustable, and/or rotationally adjustable.

Now referring back to FIG. 6, the second control 420 is depicted as a button and is thus also referred to herein as a “button” solely for purposes of simplicity and ease of explanation of the illustrated examples. The second control 420 can share certain similar features with the second control 230 (FIGS. 2A-2B). One exemplary difference between the control panel 400 and the control panel 200 is that the first control 410 and the second control 420 of the control panel 400 are disposed on opposite lateral sides of the drive assembly controls 250, 260, whereas the first control 210 and the second control 220 of the control panel 200 are disposed on the same lateral side of the drive assembly controls 250, 260. In some examples, locating the second control 420 closer to the location of the ignition switch (e.g., the location of the blank-off plate 470) on the opposite lateral side of the drive assembly controls 250, 260 from the first control 410 can simplify the design and/or assembly of the control panel 400.

Similar to the first and second controls 210, 220, the first and second controls 410, 420 can be configured such that actuating both the first control 410 and the second control 420 (e.g., in a particular order or in any one of a plurality of different orders) initiates the function of the working implement. In some examples, the first and second controls 410, 420 can be further configured such that releasing at least one of the first and second controls 410, 420 stops the function of the working implement 140, or such that releasing one of the first control 410 and the second control 420 while the working implement 140 is operating does not stop the operation of the working implement 140 so long as the other one of the first control 410 and the second control 420 remains actuated.

In yet other examples, the palm rest of the first control 410 can be configured as a pad or a platform coupled to the surface 202 of the control panel 400 and on which the operator can place their first hand. In some examples, the actuator 413 of the first control 410 can be incorporated into the pad or platform such that the actuator 413 can be actuated when the operator places the palm of their first hand on the pad or platform. In some examples, the actuator 413 can be coupled directly to the surface 202 of the control panel 400, and the operator can actuate the actuator 413 when the operator places the palm of their first hand on the surface 202.

The first control 410 and/or the second control 420 can be coupled to the hydraulic circuit 300 (FIG. 5), e.g., the working implement loop 340 (FIG. 5) of the hydraulic circuit 300, to control one or more valves thereof. For example, the first control 410 and the second control 420 can be coupled to the working implement loop 340 to control the first valve 342 (FIG. 5).

The first control 410 and the second control 420 can be electrically coupled to the first valve 342 such that the first valve 342 is configured to transition to the closed state upon actuation of both the first control 410 and the second control 420. In some examples, the first valve 342 can be configured such that de-actuating (e.g., releasing) only one of the first control 410 and the second control 420 does not transition the first valve 342 to the open state so long as the other one of the first control 410 and the second control 420 remains actuated. For example, the first control 410 and the second control 420 can be electrically coupled together to form a latch circuit, and the latch circuit can be configured to reset only upon the de-actuation of the first control 410 (e.g., upon the release of the actuator 413 of the first control 410). In some examples, the latch circuit can be configured to reset only upon the de-actuation of the second control 420.

In some examples, the first and second controls 210, 220 (FIGS. 2A-2B) can be coupled together to form a similar latch circuit for controlling the first valve 342.

In some examples, the first control 410 and the second control 420 can be electrically coupled to the first valve 342 such that the first valve 342 transitions to the open state only upon the de-actuation (e.g., release) of both the first control 410 and the second control 420.

In some examples where the second valve 344 is an electrically actuatable valve, one of the first control 410 and the second control 420 can be electrically coupled to the second valve 344. For example, the second control 420 can be electrically coupled to the second valve 344 such that actuating the second control 420 transitions the second valve 344 to the open state.

In some examples, the second valve 344 is not an electrically actuatable valve. For example, the second valve 344 can be a pressure relief valve or a counterbalance valve configured to actuate between the open state and the closed state based on a pressure differential between the upstream and downstream sides of the motor 146. When the first valve 342 transitions to the closed state, resulting in a relatively higher pressure differential between the upstream and downstream sides of the motor 146, the second valve 344 can be configured to transition to the open state in response to the increased pressure differential. When the first valve 342 transitions to the open state, resulting in a relatively lower pressure differential between the upstream and downstream sides of the motor 146, the second valve 344 can be configured to transition to the closed state in response to the decreased pressure differential. Thus, the second valve 344 can be a return side pressure relief valve configured to stop the operation of the motor 146 when the first valve 342 transitions to the open state. Thus, the second valve 344 can function as a brake configured to stop the rotation of the cutter wheel 140 coupled to the motor 146 when the first valve 342 is opened. In some examples, the fourth valve 348 can be similarly configured as a return side pressure relief valve.

Similar reference numbers (offset by hundreds) can refer to components with similar features. For example, certain examples of first controls 210, 410 can share certain similar features. Additionally or alternatively, similarly numbered components of the first controls 210, 410 (e.g., the brackets 204, 404, the cylindrical member/handle members 211, 411, and/or the actuators 213, 413) can share certain similar features. Additionally or alternatively, certain examples of the second controls 220, 420 can share certain similar features. However, it should be understood that these examples are not exhaustive, and any other components disclosed in this application that share reference numbers can potentially share certain similar features. Additionally, it should be understood that components of the various systems described herein can be combined in various ways. For example, the hydraulic machine 100 described with reference to FIGS. 1A-1B can include the control panel 400 described with reference to FIG. 6 in lieu of the control panel 200 described with reference to FIGS. 2A-2B. Furthermore, certain aspects of the control panels 200, 400 can be combined. For example, the control panel 400 can include any combination of features described with respect to the control panel 200 in the above section titled, “Additional Examples of the Disclosed Technology.” Thus, it should be understood that the additional or alternative features described in the “Additional Examples of the Disclosed Technology” section are equally applicable to the control panel 400.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A hydraulic machine comprising:
a chassis comprising a front end portion and a rear end portion;
a hydraulic working implement coupled to the front end portion of the chassis; and
a control panel disposed at the rear end portion of the chassis, wherein the control panel comprises:
a first control comprising a palm rest and an actuator coupled to the palm rest, wherein the actuator is configured to be actuated relative to the palm rest by a palm of a first hand of an operator; and
a second control spaced laterally apart from the first control and configured to be actuated by a second hand of the operator,
wherein the hydraulic machine is configured such that actuating both the first control and the second control initiates a function of the hydraulic working implement.

2. The hydraulic machine of claim 1, wherein the hydraulic working implement is centered on the front end portion of the chassis.

3. The hydraulic machine of claim 1, wherein the actuator of the first control comprises a lever pivotally coupled to the palm rest.

4. The hydraulic machine of claim 3, wherein the palm rest of the first control comprises a slot extending along a length of the palm rest, and wherein the actuator is at least partially disposed within the slot.

5. The hydraulic machine of claim 1, wherein the second control comprises a button configured to be depressed by the operator’s second hand.

6. The hydraulic machine of claim 5, wherein the button of the second control is configured such that releasing the button after the function of the hydraulic working implement has been initiated does not stop the function of the hydraulic working implement.

7. The hydraulic machine of any one of claim 1, wherein the palm rest of the first control is positionally adjustable, length-adjustable, rotationally adjustable, or any combination thereof.

8. The hydraulic machine of claim 1, wherein:
the hydraulic machine comprises an arm comprising a first end portion and a second end portion, wherein the first end portion of the arm is coupled to the front end portion of the chassis;
the hydraulic working implement is coupled to the second end portion of the arm; and
the hydraulic machine further comprises a third control configured to control a movement of the arm relative to the chassis.

9. The hydraulic machine of claim 8, wherein the hydraulic machine is a stump grinder and the hydraulic working implement is a cutter wheel, and the stump grinder is configured such that actuating both the first control and the second control initiates rotation of the cutter wheel.

10. The hydraulic machine of claim 9, wherein the first control and the third control are operable with the operator’s first hand.

11. The hydraulic machine of claim 10, wherein the third control comprises a lever with a grip portion configured to be actuated by at least one finger of the operator’s first hand while the palm of the operator’s first hand is in contact with the first control.

12. The hydraulic machine of claim 9, wherein the third control is configured as a lift lever to control vertical movement of the arm relative to the chassis.

13. The hydraulic machine of claim 12, wherein the second control is spaced apart in the lateral direction from the third control.

14. The hydraulic machine of claim 13, further comprising a fourth control configured as a sweep lever to control horizontal movement of the arm relative to the chassis.

15. The hydraulic machine of claim 1, further comprising drive assembly controls, and wherein the first control is disposed on a first lateral side of the drive assembly controls and the second control is a button disposed on a second lateral side of the drive assembly controls.

16. A stump grinder comprising:
a chassis comprising a front end portion and a rear end portion;
an arm comprising a first end portion and a second end portion, wherein the first end portion of the arm is coupled to the front end portion of the chassis, and wherein the arm is configured to move in at least one of a horizontal direction and a vertical direction relative to the chassis;
a cutter wheel coupled to the second end portion of the arm; and
a control panel disposed at the rear end portion of the chassis, wherein the control panel comprises:
a first control configured as a palm-actuated switch assembly comprising a lever configured to be actuated by a palm of a first hand of an operator; and
a second control configured as a button spaced apart in a lateral direction from the palm-actuated switch assembly, wherein the button is configured to be actuated by a second hand of the operator,
wherein the stump grinder is configured such that actuating both the palm-actuated switch assembly and the button initiates a rotation of the cutter wheel.

17. The stump grinder of claim 16, wherein the control panel comprises a third control configured as a lift lever to control vertical movement of the arm relative to the chassis.

18. The stump grinder of claim 17, wherein the lift lever comprises a grip portion configured to be actuated by at least one finger of the operator’s first hand while the palm of the operator’s first hand is in contact with the palm-actuated switch assembly.

19. The stump grinder of claim 18, wherein the control panel comprises a fourth control configured as a sweep lever to control horizontal movement of the arm relative to the chassis, and wherein the sweep lever is spaced apart from the palm switch assembly and the lift lever and configured to be actuated by the operator’s second hand.

20. The stump grinder of claim 19, wherein the control panel further comprises drive assembly controls, wherein the palm-actuated switch assembly is disposed on a first lateral side of the drive assembly controls, and wherein the button is disposed on a second lateral side of the drive assembly controls.
